(19) United States
(12) Patent Application Publication
(10) Pub. No.: US 2010/0027394 A1
(43) Pub. Date: Feb. 4, 2010

(54) SERVO CALIBRATION MARK DETECTION CIRCUIT FOR HD-DVD OR DVD-RAM AND METHOD THEREOF

(75) Inventors: Hung-Chieh Tsai, Tainan Hsien (TW); Yu-Hsuan Lin, Hsinchu City (TW); Hsiang-Ji Hsieh, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/577,829

(22) Filed: Oct. 13, 2009

Related U.S. Application Data
(62) Division of application No. 11/752,447, filed on May 23, 2007.
(60) Provisional application No. 60/803,629, filed on Jun. 1, 2006.
(60) Provisional application No. 60/804,834, filed on Jun. 15, 2006.

(51) Int. Cl. G11B 27/36

(52) U.S. Cl. 369/53.2

(57) ABSTRACT

The invention provides a servo calibration mark detection circuit for use in an optical disk drive. In one embodiment, the servo calibration mark detection circuit comprises a summing processor, a slicing level generator, and a comparator. The summing processor sums an intensity of a light beam reflected from both an inner groove and an outer groove to obtain a first signal. The slicing level generator generates a slicing level. The comparator then compares the first signal with the slicing level to obtain a second signal, wherein the second signal indicates a first location of a first servo calibration mark recorded on the inner groove and a second location of a second servo calibration mark recorded on the outer groove.

### CROSS REFERENCE TO RELATED APPLICATIONS

This application is Divisional application of U.S. application Ser. No. 11/752,447, filed on May 23, 2007, which claims the benefit of U.S. Provisional Application No. 60/803,629, filed on Jun. 1, 2006, and U.S. Provisional Application No. 60/804,834, filed on Jun. 15, 2006, the entirety of which are incorporated by reference herein.

### BACKGROUND OF THE INVENTION

1. Field of the Invention

The invention relates to optical disks, and more particularly to Servo Calibration Mark (SCM) detection of optical disks.

2. Description of the Related Art

An optical disk drive reads data from an optical disk by detecting the intensity of a laser beam reflected by the pits and lands on tracks of the optical disk. Tilt, however, may occur when the plane of the optical disk is not perpendicular to the incident laser beam. This can occur when the clamping surface of the optical disk drive is misaligned. If tilt exists, the focus spot of a laser beam is properly projected on the optical disk at a common point, causing data reading errors. Thus, tilt must be compensated while the optical disks are read. The tilt compensation is also referred to as “tilt balance”.

Servo calibration marks in High Definition Digital Versatile Discs (HD-DVD) or Digital Versatile Disc-Read Only Memory (DVD-RAM), are tiny marks recorded in the tracks of an optical disk, for tilt balance. Servo calibration marks are only recorded near boundaries of different zones of the HD-DVD track. FIG. 1 is a schematic diagram of the servo calibration marks recorded on two adjacent grooves of an HD-DVD. The two adjacent grooves include an inner groove 130 and an outer groove 110. Between the two grooves 110 and 130 is a land region. The address information of track data is recorded in the form of modulated wobbles in the grooves 110 and 130 and includes a Normal Phase Wobble (NPW) indicating “0” and an Inverted Phase Wobble (IPW) indicating “1”. Two categories of servo calibration marks are recoded on the grooves 110 and 130. The first servo calibration mark, SCM1, is symmetrically recoded on both the inner and outer grooves 130 and 110, as servo calibration marks 112 and 132 shown in FIG. 1. The second servo calibration mark, SCM2, is asymmetrically recorded at different locations of the inner and outer grooves 130 and 110, as servo calibration marks 114 and 134 shown in FIG. 1. The groove structure of the servo calibration marks is partially removed to build land parts thereon.

A focused spot 102 of a laser beam is projected on the surface of the HD-DVD by a HD-DVD drive and moves along the track to read data. The focused spot 102 can simultaneously scan data recorded on both the inner groove 130 and the outer groove 110. The focused spot 102 is divided into four quadrants A, B, C, and D respectively detectable by a photodetector. Thus, the intensity of the laser beam reflected from the inner groove 130 is indicated by (B+C), and the intensity of the laser beam reflected from the outer groove 110 is indicated by (A+D).

FIG. 2a is a plan view of a first servo calibration mark recorded in both the inner and outer grooves 204 and 202. The first servo calibration mark includes multiple land parts iteratively formed on both the inner groove 204 and outer groove 202. Each land part of the first servo calibration mark extends duration of 8T. As previously stated, the first servo calibration mark 206 recorded on the inner groove 204 is symmetrical to the first servo calibration mark 208 recorded on the outer groove 202. FIG. 2b shows the laser beam reflection intensity received by a peak-up head while the first servo calibration mark of FIG. 2a is read. As a laser beam projected on both the inner groove 204 and the outer groove 202 moves steadily along the grooves as shown in FIG. 1, the intensity of the reflection of the laser beam is obtained as shown in FIG. 2b. Because the first servo calibration mark is substantially repeated on land parts in the groove, the intensity of reflection is increased with each occurrence of a land part of the first servo calibration mark. Thus, the waveform of the laser beam reflection intensity is similar to a sine wave or glitches while the first servo calibration mark is read.

FIG. 3a is a plan view of a second servo calibration mark recorded in both the inner and outer grooves 304 and 302. The second servo calibration mark includes a servo calibration mark 306 formed on the inner groove 304 and a servo calibration mark 308 formed on the outer groove 302. The duration of both servo calibration mark 306 and 308 is two wobbles. As previously stated, the second servo calibration mark 306 recorded on the inner groove 304 is asymmetrical to the second servo calibration mark 308 recorded on the outer groove 302. FIG. 3b shows the intensity of the reflection of laser beam received by a peak-up head while the second servo calibration mark of FIG. 3a is read. As a laser beam projected on both the inner groove 304 and the outer groove 302 moves steadily along the grooves as shown in FIG. 1, the intensity of the reflection of the laser beam is obtained as shown in FIG. 3b. Because the servo calibration mark 306 of the inner grove 304 occurs earlier than the servo calibration mark 308 of the outer groove 302, the reflection intensity is raised for two times in response to both the second servo calibration marks 306 and 308. Thus, two peaks P₁ and P₂ occur in the waveform of the laser beam reflection intensity while the second servo calibration mark is read, wherein the peaks P₁ and P₂ respectively correspond to the second servo calibration marks 306 and 308.

FIG. 4 is a block diagram of a circuit 400 for determining the expected location of servo calibration marks. A pick-up head of an optical disk drive first detects the wobble data stored in the grooves. The wobble data is then delivered to a wobble signal processor 402, which converts the wobble data to a series of data bits 0 or 1, and the wobble data bits are further decoded by a wobble decoder 404. Since the wobble data stores the address information and the relative locations of servo calibration marks to the wobble data section are invariable, an SCM indicator 406 can then further determines the expected locations of the servo calibration marks according to the wobble data decoded by the wobble decoder 406. The pick-up head of the optical disk drive can then read the servo calibration marks according to the expected locations, and tilt balance can then be implemented according to the data of the servo calibration marks.

The circuit 400 of FIG. 4 requires wobble data to determine expected locations of servo calibration marks. At the beginning of tracking-on, however, the wobble data can not be read, and the locations of servo calibration marks cannot be determined by the circuit 400 without the wobble data. Because the locations of the servo calibration marks are not determined, the servo calibration marks cannot be read and tilt of the optical disk cannot be compensated. Thus, methods for detecting servo calibration marks of an optical disk drive are required.

### BRIEF SUMMARY OF THE INVENTION

The invention provides a servo calibration mark detection circuit for use in an optical disk drive. In one embodiment, the servo calibration mark detection circuit comprises a summing processor, a slicing level generator, and a comparator. The summing processor sums an intensity of a light beam reflected from both an inner groove and an outer groove to obtain a first signal. The slicing level generator generates a slicing level. The comparator then compares the first signal with the slicing level to obtain a second signal, wherein the second signal indicates a first location of a first servo calibration mark recorded on the inner groove and a second location of a second servo calibration mark recorded on the outer groove.

The invention also provides a method for detecting servo calibration marks of an optical disk drive. First, an intensity of a light beam reflected from both an inner groove and an outer groove is summed to obtain a first signal. A slicing level is then generated. The first signal is then compared with the slicing level to generate a second signal, wherein the second signal indicates a first location of a first servo calibration mark recorded on the inner groove and a second location of a second servo calibration mark recorded on the outer groove.

The invention also provides a servo calibration mark detection circuit for use in an optical disk drive. The servo calibration mark detection circuit comprises a push-pull processor, a slicing level generator, a first comparator, a second comparator, and a combining unit. The push-pull processor subtracts a first intensity of a light beam reflected from an inner groove from a second intensity of a light beam reflected from an outer groove to obtain a first signal. The slicing level generator generates a first slicing level and a second slicing level. The first comparator compares the first signal with the first slicing level to obtain a second signal indicating a first location of a first servo calibration mark recorded on the inner groove. The second comparator compares the first signal with the second slicing level to obtain a third signal indicating a second location of a second servo calibration mark recorded on the outer groove. The combining unit combines the second signal with the third signal to obtain a fourth signal, wherein the fourth signal indicates both the first location and the second location.

The invention also provides a method for detecting servo calibration marks of an optical disk drive. First, a first intensity of a light beam reflected from an inner groove is subtracted from a second intensity of a light beam reflected from an outer groove to obtain a first signal. A first slicing level and a second slicing level are then generated. The first signal is then compared with the first slicing level to obtain a second signal indicating a first location of a first servo calibration mark recorded on the inner groove. The first signal is then compared with the second slicing level to obtain a third signal indicating a second location of a second servo calibration mark recorded on the outer groove. The second signal is then combined with the third signal to obtain a fourth signal, wherein the fourth signal indicates both the first location and the second location.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of the servo calibration marks recorded on two adjacent grooves of a HD-DVD;

FIG. 2a is a plan view of a first servo calibration mark recorded in both the inner and outer grooves;

FIG. 2b shows the laser beam reflection intensity received by a peak-up head while the first servo calibration mark of FIG. 2a is read;

FIG. 3a is a plan view of a second servo calibration mark recorded in both the inner and outer grooves;

FIG. 3b shows the laser beam reflection intensity received by a peak-up head while the second servo calibration mark of FIG. 3a is read;

FIG. 4 is a block diagram of a circuit for determining expected servo calibration marks locations;

FIG. 5 is a block diagram of a servo calibration mark detection circuit according to the invention;

FIG. 6 is a flowchart of a method for detecting servo calibration marks according to the invention;

FIG. 7 shows the timing of the signals generated by the servo calibration mark detection circuit of FIG. 5;

FIG. 8 is a block diagram of another servo calibration mark detection circuit according to the invention;

FIG. 9 is a flowchart of another method for detecting servo calibration marks according to the invention; and

FIG. 10 shows the timing of the signals generated by the servo calibration mark detection circuit of FIG. 8.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

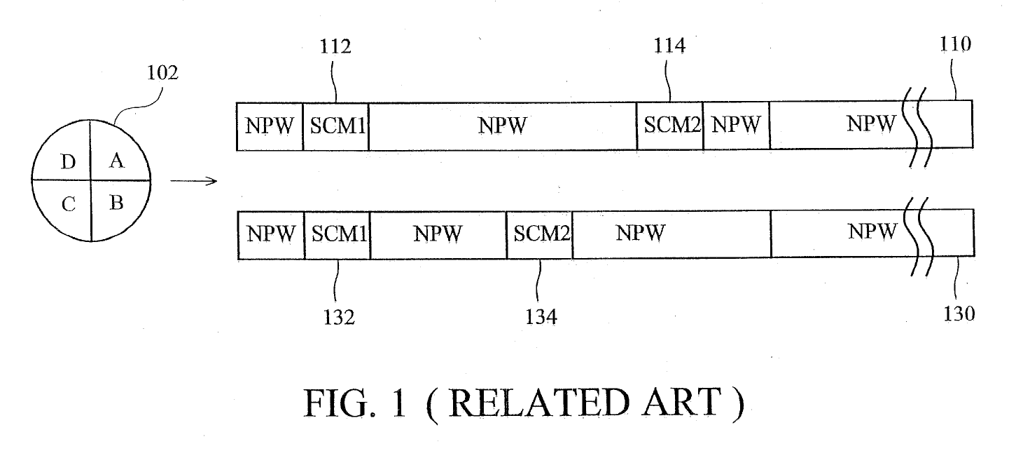

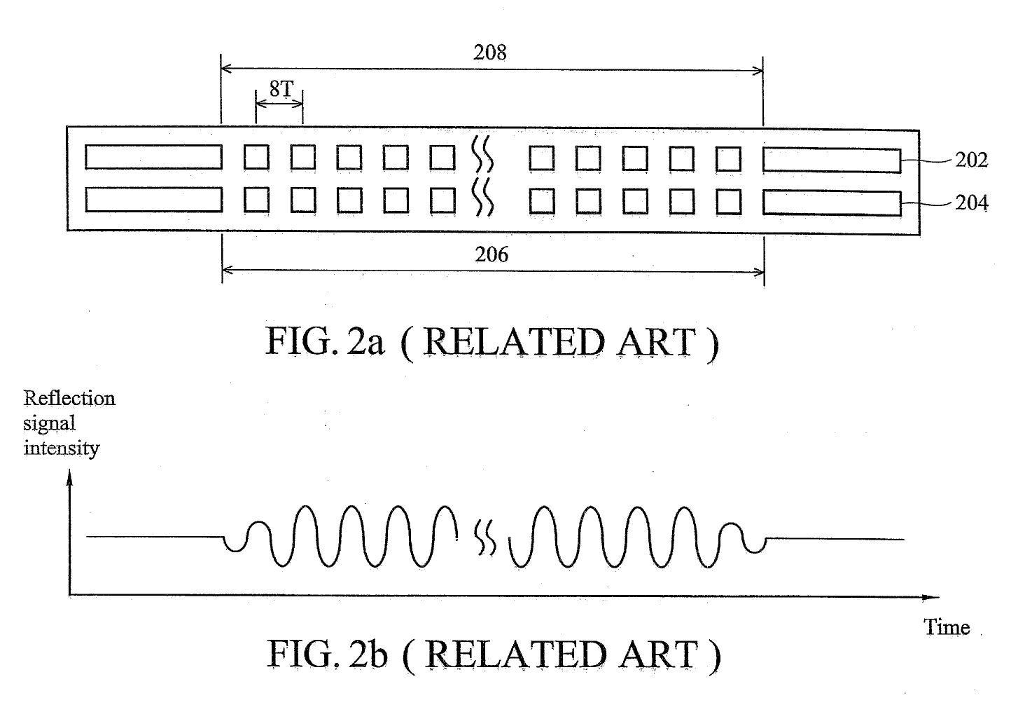

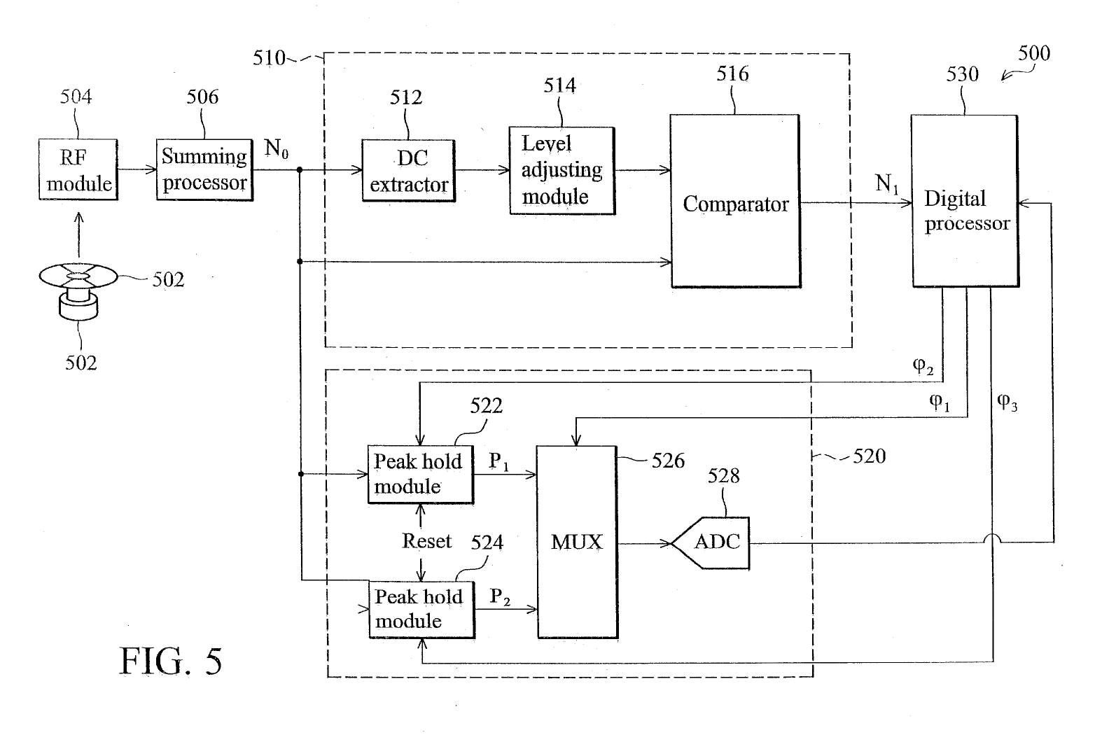

FIG. 5 is a block diagram of a servo calibration mark detection circuit 500 according to the invention. The servo calibration mark detection circuit 500 included by an optical disk drive detects servo calibration marks of an optical disk 502. In one embodiment, the optical disk 502 is a High Definition Digital Versatile Disc (HD-DVD). A radio frequency module 504 of the optical disk drive uses a laser beam to simultaneously scan data recorded on two adjacent grooves, an inner groove and an outer groove, of the optical disk 502, as the focused spot 102 shown in FIG. 1, scanning data recorded on both the inner groove 130 and the outer groove 110. In one embodiment, the radio frequency module 504 is a pick-up head of the optical disk drive. The servo calibration marks include servo calibration marks symmetrically recoded on both the inner and outer grooves, such as the SCM1 132 and 112 shown in FIG. 1, and servo calibration marks asymmetrically recorded at different locations of the inner and outer grooves, such as SCM2 134 and 114 shown in FIG. 1.

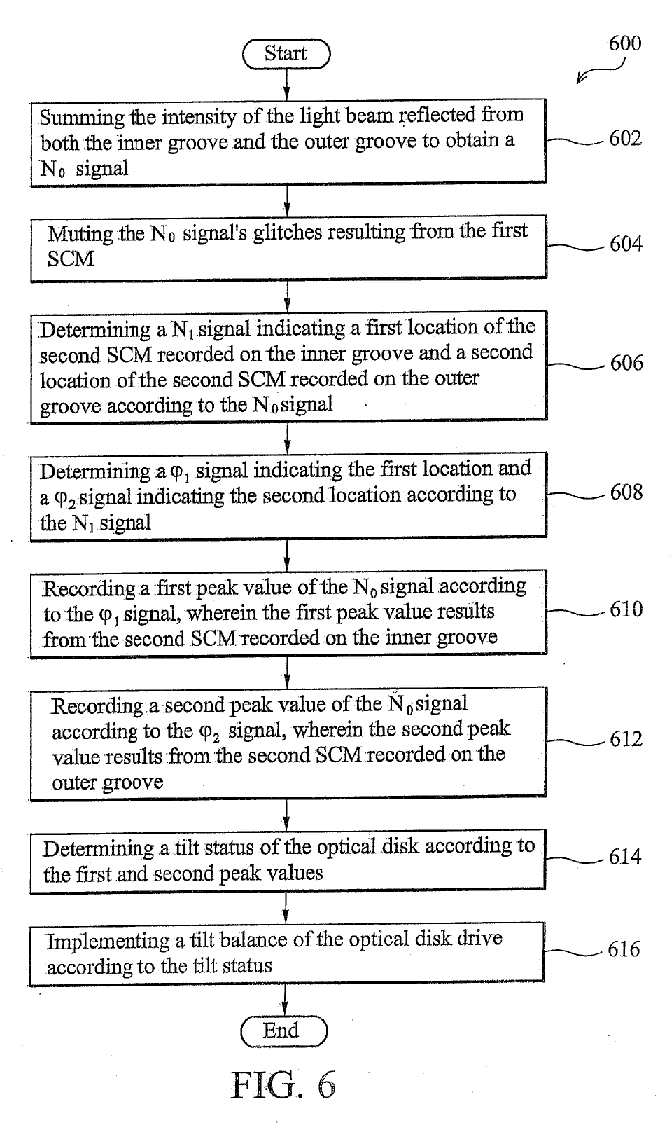

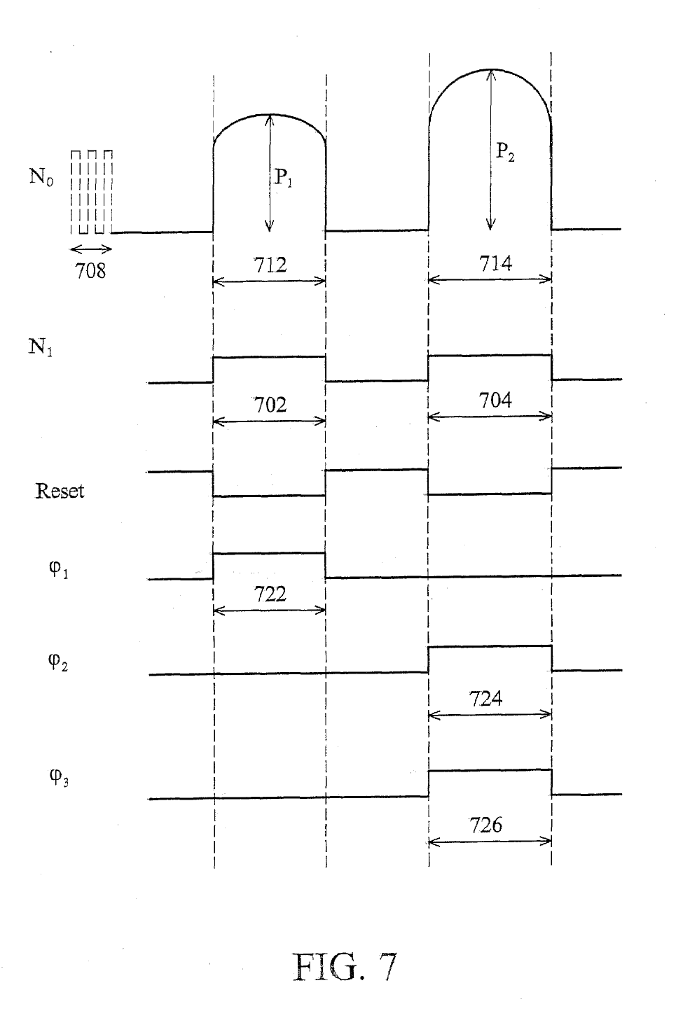

The servo calibration mark detection circuit 500 includes a summing processor 506, a SCM location detection circuit 510, a digital processor 530, and a SCM peak detection circuit 520. FIG. 6 is a flowchart of a method 600 for detecting servo calibration marks according to the invention. Servo calibration mark detection circuit 500 implements the method 600 to detect the servo calibration marks. The summing processor 506 first sums the intensity of the laser beam reflected from both the inner groove and the outer groove in step 602 to obtain a signal N₀. Because the reflected laser beam is divided into four quadrants A, B, C, and D, respectively detected by a photodetector according to FIG. 1, (A+D) and (B+C) respectively indicates the intensity of the laser beam reflected from the outer groove and inner groove, and the signal N₀ output by the summing processor 506 is (A+B+C+D). FIG. 7 shows the signal N₀ generated by the summing processor 506. The region 708 of signal N₀ corresponds to SCM1, and the regions 712 and 714 of signal N₀ respectively corresponds to the second SCM2 recorded on the inner groove and outer groove.

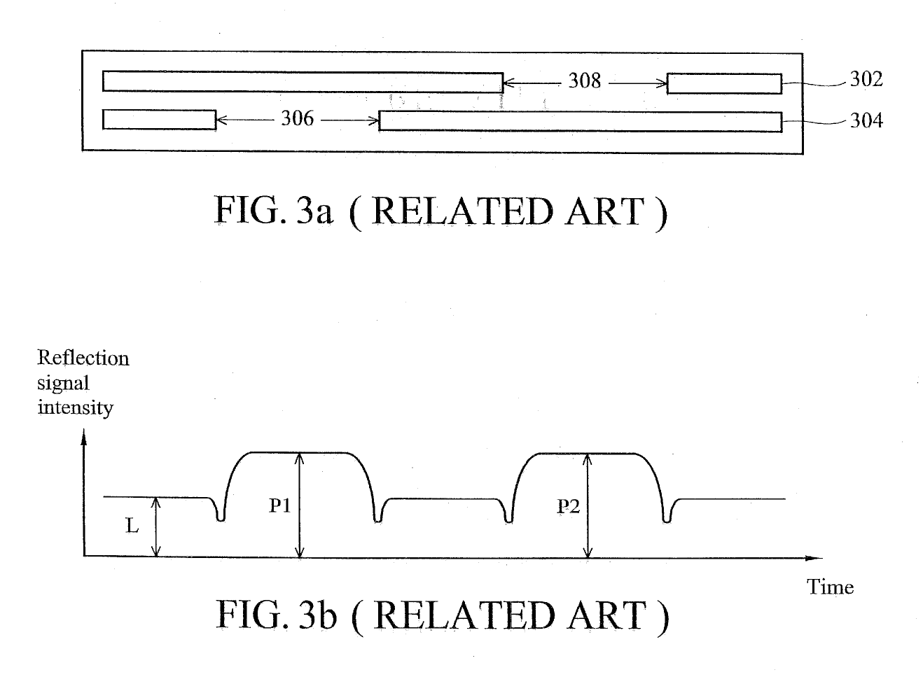

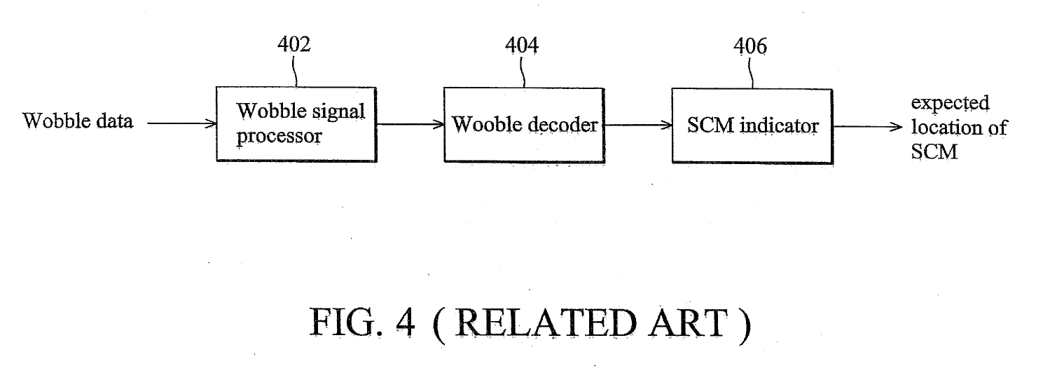

Because in this embodiment only SCM2 are required for implementing tilt balance, the digital processor 530 mutes the signal N₀'s glitches 708 resulting from SCM1 in step 604. The SCM location detection circuit 510 then detects the locations of SCM2 recorded on both the inner and outer grooves in step 606 according to the signal N₀. The SCM location detection circuit 510 includes a slicing level generator, and a comparator 516. In this embodiment, the slicing level generator 512 is implemented by a direct current (DC) extractor 512, and a level adjusting module 514. The direct current extractor 512 then extracts a DC (direct current) portion of the signal N₀ as a slicing level, wherein the DC portion is approximately the portion L shown in FIG. 3b. The level adjusting module 514 then adjusts the level of the DC portion to obtain an adjusted DC portion. The comparator 516 then compares the signal N₀ with the slicing level. The slicing level is the adjusted DC portion of the signal N₀ in this embodiment. After the comparing operation, the comparator 516 generates a signal N₁ as shown in FIG. 7. The regions 702 and 704 of the signal N₁ respectively indicate the locations of SCM2 recorded on the inner groove and the outer groove.

The digital processor 530 then determines a signal φ1 indicating the location of the SCM2 recorded on the inner groove and a signal φ2 indicating the location of the SCM2 recorded on the outer groove in step 608 according to the signal N₁. Both the signals φ1 and φ2 are shown in FIG. 7, wherein the region 722 of the signal φ1 corresponds to the SCM2 recorded on the inner groove, and the region 724 of the signal φ2 corresponds to the SCM2 recorded on the outer groove.

The SCM peak detection circuit 520 then detects the peak levels of SCM2 recorded at the inner and outer grooves according to the signal N₀, φ1, and φ2. The SCM peak detection circuit 520 includes two peak hold modules 522 and 524, a multiplexer 526, and an analog-to-digital circuit 528. The peak hold module 522 records a peak value P₁ of the signal N₀ in step 610 during the enabling period 722 of the signal φ₁. Because the enabling period 722 of the signal φ₁ corresponds to SCM2 recorded on the inner groove, the peak value P₁ of the signal N₀ corresponds to SCM2 recorded on the inner groove. The peak hold module 524 records a peak value P₂ of the signal N₀ in step 612 during the enabling period 724 of the signal φ₂. Because the enabling period 724 of the signal φ₂ corresponds to SCM2 recorded on the outer groove, the peak value P₂ of the signal N₀ corresponds to SCM2 recorded on the outer groove.

Before the peak values P₁ and P₂ are delivered to the digital processor 530, the peak values P₁ and P₂ must first be converted to digital values. The multiplexer 526 then multiplexes the peak values P₁ and P₂ according to a signal φ₃ generated by the digital processor 530, wherein the signal φ₃ is also shown in FIG. 7. Thus, the peak values P₁ and P₂ are sequentially delivered to the analog-to-digital converter 528, which converts the peak values P₁ and P₂ from analog to digital. Because the peak values P₁ and P₂ are actually the laser beam intensity reflected SCM2 recorded in the inner and outer grooves, the peak value P₁ is not equal to the peak value P₂ if the inner and outer grooves are not at the same distance away from the photodetectors, that is to say, tilt occurs and requires compensation to facilitate data reading. Thus, the digital processor 530 then determines a tilt status of the optical disk in step 614 according to the peak values P₁ and P₂, and a tilt balance of the optical disk drive is implemented according to the tilt status in step 616. Thus, the servo calibration mark detection circuit 500 detects servo calibration marks to implement tilt balance without wobble data.

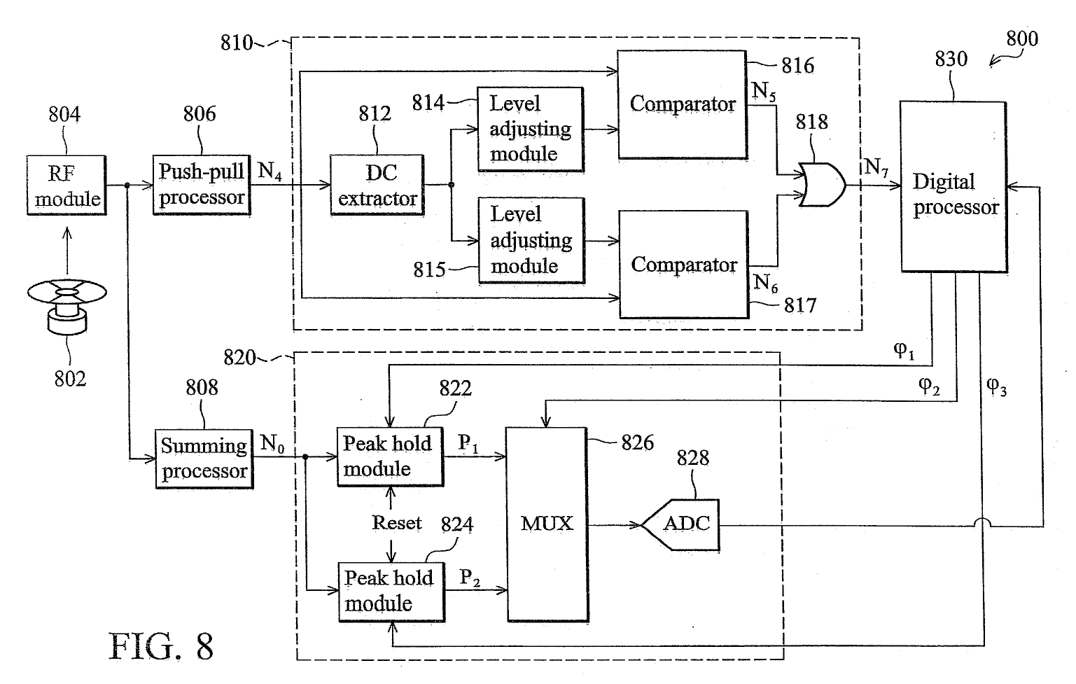

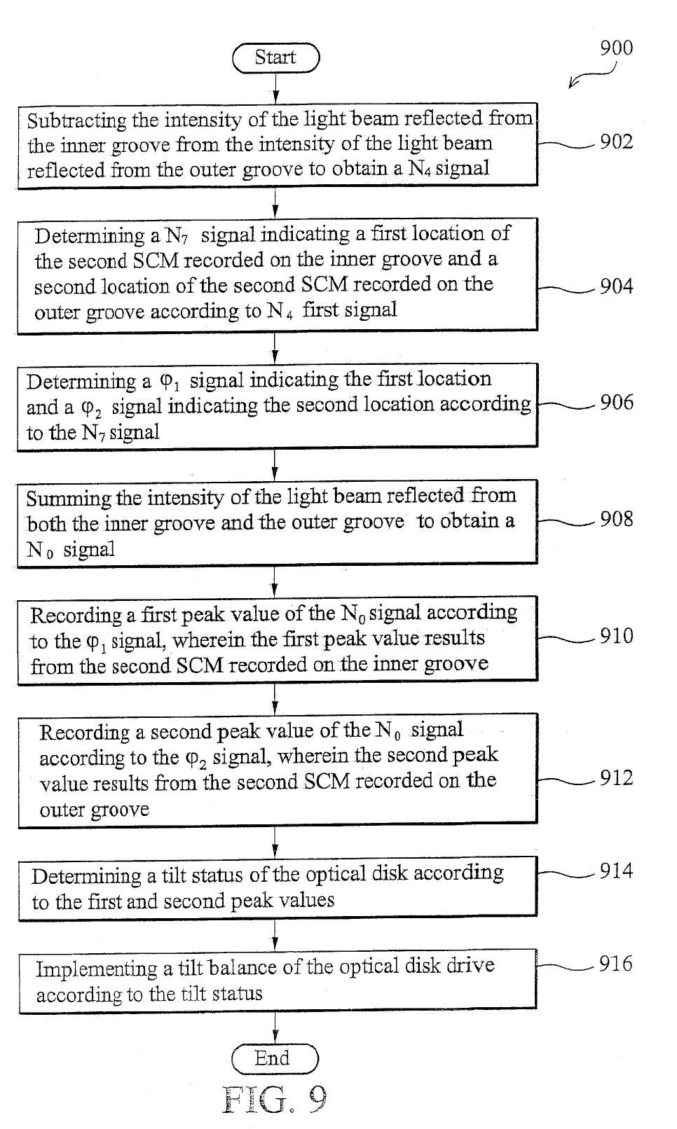

FIG. 8 is a block diagram of a servo calibration mark detection circuit 800 according to the invention. The servo calibration mark detection circuit 800 implements a method 900 shown in FIG. 9 to detect the servo calibration marks. The servo calibration mark detection circuit 800 is approximately similar to the servo calibration mark detection circuit 500 shown in FIG. 5, with the exception of an added push-pull processor 806 and SCM location detection circuit 810 slightly varied from SCM location detection circuit 510 of FIG. 5. Thus, only the differences between the servo calibration mark detection circuit 800 and 500 are described in the following.

Since the servo calibration mark detection circuit 500 of FIG. 5 simply sums the intensity of the light beam reflected from both the inner groove and the outer groove with the summing processor 506, the signal N₀ possesses the glitches 708 due to SCM 1, and the digital processor 530 must suppress the glitches 708. Otherwise, the glitches 708 may cause errors in the generated signal N₁. Thus, the digital processor 530 must comprise some modules responsible for eliminating glitches 708 of signal N₀. This burdens digital processor 530 with additional load and complicates the design of the digital processor 530.

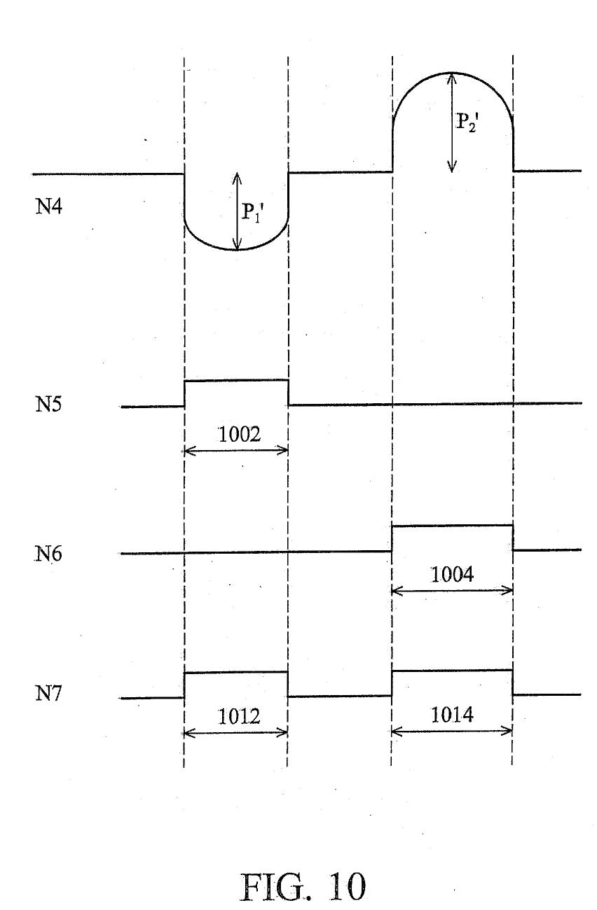

To avoid the described defects, a push-pull processor 806 is introduced in the servo calibration mark detection circuit 800. The push-pull processor 806 subtracts the intensity of the light beam reflected from the inner groove from the intensity of the light beam reflected from the outer groove in step 902 to obtain a signal N₄. If the reflected laser beam is divided into four quadrants A, B, C, and D, respectively detected by a photodetector according to FIG. 1, the signal N₄ output by the push-pull processor 806 is (A+D−B−C). As shown in FIG. 10, the signal N₄ does not carry glitches due to SCM1, because the glitches are canceled due to the algorithm (A+D−B−C). In another embodiment, the glitches become small because of the partial cancellation of (A+D) and (B+C). Since the glitches are completely cancelled or become smaller, there may be no need to have extra modules responsible for suppressing glitches in the servo calibration mark detection circuit 800, and the design of the digital processor 830 is simplified.

The SCM location detection circuit 810 then detects the locations of SCM2 recorded on both the inner and outer grooves in step 904 according to the signal N₄. The SCM location detection circuit 810 includes a slicing level generator, two comparators 816 and 817, and a combining unit 818. In this embodiment, the slicing level generator is implemented by a DC extractor 812 and two level adjusting modules 814 and 815. The DC extractor 812 first extracts a DC portion of the signal N₄. Because the peak P₁′ of the signal N₄ is not positive as is the peak P₁ of the signal N₀, the expected locations of SCM2 require different treatment. The level adjusting modules 814 and 815 then adjust the level of the DC portion to obtain two different adjusted DC portions as two slicing levels (a first slicing level and a second slicing level). The comparator 816 compares the signal N4 with the first slicing level to obtain a signal N5 (shown in FIG. 10). The comparator 817 compares the signal N4 with the second slicing level to obtain a signal N6. The regions 1002 of the signal N₅ and the region 1004 of the signal N₆ respectively indicate the locations of the SCM2 recorded on the inner groove and the outer groove. In this embodiment, the combining unit 818 is implemented by an OR gate. The OR gate 818 then executes an OR function on the signals N₅ and N₆ to obtain a signal N₇. As shown in FIG. 10, the regions 1012 and 1014 of the signal N₇ indicate the locations of SCM2.

The digital processor 830 then derives signals φ1 and φ2 shown in FIG. 7 from the signal N₇ in step 906. If a summing processor 808 sums the intensity of the light beam reflected from both the inner groove and the outer groove to obtain the signal N₀ in step 908, the peak hold modules 822 and 824 then respectively record the peak values P₁ and P₂ of the signal N₀ in steps 910 and 912 according to the signals φ1 and φ2. Finally, the digital processor 830 determines a tilt status of the optical disk according to the peak values P₁ and P₂ in step 914, and a tilt balance of the optical disk drive is implemented according to the tilt status in step 916. Thus, the servo calibration mark detection circuit 800 also detects servo calibration marks to implement tilt balance without the presence of wobble data.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A servo calibration mark detection circuit for use in an optical disk drive, the servo calibration mark detection circuit comprising:
a push-pull processor, subtracting a first intensity of a light beam reflected from an inner groove from a second intensity of a light beam reflected from an outer groove to obtain a first signal;
a slicing level generator for generating a first slicing level and a second slicing level;
a first comparator for comparing the first signal with the first slicing level to obtain a second signal indicating a first location of a first servo calibration mark recorded on the inner groove;
a second comparator for comparing the first signal with the second slicing level to obtain a third signal indicating a second location of a second servo calibration mark recorded on the outer groove; and
a combining unit for combining the second signal with the third signal to obtain a fourth signal;
wherein the fourth signal indicates both the first location and the second location.

2. The servo calibration mark detection circuit as claimed in claim 1, wherein the slicing level generator comprises:
a DC extractor for extracting a DC portion from the first signal;
a first level adjusting module for adjusting a level of the DC portion to form the first slicing level; and
a second level adjusting module for adjusting a level of the DC portion to form the second slicing level.

3. The servo calibration mark detection circuit as claimed in claim 1, wherein the combining unit is an OR gate.

4. The servo calibration mark detection circuit as claimed in claim 1, wherein the servo calibration mark detection circuit further comprises a digital processor, coupled to the combining unit, determining a fifth signal indicating the first location and a sixth signal indicating the second location according to the fourth signal.

5. The servo calibration mark detection circuit as claimed in claim 4, wherein the servo calibration mark detection circuit further comprises:
a summing processor, summing an intensity of a light beam reflected from both the inner groove and the outer groove to obtain a seventh signal;
a first peak hold module, coupled to the summing processor and the digital processor, recording a first peak value of the seventh signal according to the fifth signal, wherein the first peak value results from the first servo calibration mark recorded on the inner groove; and
a second peak hold module, coupled to the summing processor and the digital processor, recording a second peak value of the seventh signal according to the sixth signal, wherein the second peak value results from the second servo calibration mark recorded on the outer groove.

6. The servo calibration mark detection circuit as claimed in claim 5, wherein the first and second peak values are delivered to the digital processor, the digital processor determines a tilt status of the optical disk according to the first and second peak values, and a tilt balance of the optical disk drive is implemented according to the tilt status.

7. The servo calibration mark detection circuit as claimed in claim 5, wherein the servo calibration mark detection circuit further comprises:
a multiplexer, coupled to the digital processor and the first and second peak hold modules, multiplexing the first and second peak values according to a eighth signal generated by the digital processor; and
an analog to digital converter, coupled to the multiplexer, converting the first and second peak values from an analog form to a digital form before the first and second peak values are delivered to the digital processor.

8. The servo calibration mark detection circuit as claimed in claim 1, wherein the optical disk drive is a HD-DVD drive.

9. A method for detecting servo calibration marks of an optical disk drive, the method comprising:
subtracting a first intensity of a light beam reflected from an inner groove from a second intensity of a light beam reflected from an outer groove to obtain a first signal;
generating a first slicing level and a second slicing level;
comparing the first signal with the first slicing level to obtain a second signal indicating a first location of a first servo calibration mark recorded on the inner groove;
comparing the first signal with the second slicing level to obtain a third signal indicating a second location of a second servo calibration mark recorded on the outer groove; and
combining the second signal with the third signal to obtain a fourth signal, wherein the fourth signal indicates both the first location and the second location.

10. The method as claimed in claim 9, wherein the step of generating the first slicing level and the second slicing level comprises:
extracting a DC portion from the first signal;
adjusting a level of the DC portion to form the first slicing level; and
adjusting a level of the DC portion to form the second slicing level.

11. The method as claimed in claim 9, wherein the method further comprises:
determining a fifth signal indicating the first location and a sixth signal indicating the second location according to the fourth signal;
summing an intensity of a light beam reflected from both the inner groove and the outer groove to obtain a seventh signal;
recording a first peak value of the seventh signal according to the fifth signal, wherein the first peak value results from the first servo calibration mark recorded on the inner groove; and
recording a second peak value of the seventh signal according to the sixth signal, wherein the second peak value results from the second servo calibration mark recorded on the outer groove.

12. The method as claimed in claim 11, wherein the method further comprises:
determining a tilt status of the optical disk according to the first and second peak values; and
implementing a tilt balance of the optical disk drive according to the tilt status.
